(19) United States
(12) Patent Application Publication
(10) Pub. No.: US 2023/0074670 A1
(43) Pub. Date: Mar. 9, 2023

(54) SYSTEMS AND METHODS FOR CELL DESIGN

(71) Applicant: ZTE CORPORATION, Shenzhen (CN)

(72) Inventors: Xingguang WEI, Shenzhen (CN); Peng HAO, Shenzhen (CN); Jing SHI, Shenzhen (CN); Kai XIAO, Shenzhen (CN)

(21) Appl. No.: 17/950,734

(22) Filed: Sep. 22, 2022

Related U.S. Application Data
(63) Continuation of application No. PCT/CN2021/076477, filed on Feb. 10, 2021.

(51) Int. Cl. H04L 5/00

(52) U.S. Cl. CPC H04L 5/0035; H04L 5/0098

(57) ABSTRACT

A wireless communication method includes transmitting, by a base station, first downlink information to a wireless communication device in a downlink carrier in a first cell; and receiving, by the base station, first uplink information from the wireless communication device in an uplink carrier in the first cell.

### CROSS-REFERENCE TO RELATED APPLICATION

This application claims the benefit of priority under 35 U.S.C. § 120 as a continuation of PCT Patent Application No. PCT/CN2021/076477, filed on Feb. 10, 2021, the disclosure of which is incorporated herein by reference in its entirety.

### TECHNICAL FIELD

The disclosure relates generally to wireless communications and, more particularly, to systems and methods for different cell designs for wireless communication.

### BACKGROUND

In 5G systems, one Cell normally includes of one Downlink (DL) carrier and one Uplink (UL) carrier. The DL carrier is used for transmitting signals/channels from network to User Equipment (UE), and the UL carrier is used for transmitting signals/channels from UE to network. In the case of Carrier Aggregation (CA), the Primary Cell (PCell) always includes of one DL carrier and one UL carrier. However, the Secondary Cell (SCell) can include of one DL carrier and one UL carrier, or include of only one DL carrier without UL carrier. A cell with only the DL carrier is used for increasing DL throughput.

One Cell can also include of one DL carrier and two UL carriers. If there are two UL carriers, one of the two UL carriers is a supplementary UL (SUL). In this case, the two UL carriers cannot transmit UL signals/channels simultaneously. In current systems, the supplementary UL is mainly used for improving UL coverage.

The current design of Cell in 5G systems is mainly for DL-centric traffic. With the rapid development of mobile communication, more UL-centric applications are emerging (e.g., machine vision), but the current design of Cell in 5G systems are not suitable for this UL-centric traffic.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some arrangements, User Equipment (UE) performs a method including receiving, from a Base Station (BS), first downlink information in a downlink carrier in a first cell; and transmitting, to the BS, first uplink information in an uplink carrier in the first cell.

In other arrangements, a BS performs a method including transmitting first downlink information to a UE in a downlink carrier in a first cell; and receiving first uplink information from the UE in an uplink carrier in the first cell.

In other embodiments, a wireless communications apparatus comprising a processor and a memory, wherein the processor is configured to read code from the memory and implement a method including receiving, from a BS, first downlink information in a downlink carrier in a first cell; and transmitting, to the BS, first uplink information in an uplink carrier in the first cell.

In other embodiments, a computer program product comprising a computer-readable program medium code stored thereupon, the code, when executed by a processor, causing the processor to implement a method including receiving, from a BS, first downlink information in a downlink carrier in a first cell; and transmitting, to the BS, first uplink information in an uplink carrier in the first cell.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a schematic diagram of a first design of a cell, according to various embodiments.

FIG. 2 is a schematic diagram illustrating simultaneous uplink transmission in 3 uplink carriers in the same cell, according to various embodiments.

FIG. 3 is a schematic diagram of a second design of cells, according to various embodiments.

FIG. 4 is a schematic diagram of a third design of cells, according to various embodiments.

FIG. 5 is a schematic diagram of a fourth design of cells, according to various embodiments.

FIG. 6A is a flowchart diagram illustrating an example wireless communication method utilizing cell design, according to various embodiments.

FIG. 6B is a flowchart diagram illustrating an example wireless communication method for utilizing cell design, according to various embodiments.

FIG. 7A illustrates a block diagram of an example user equipment, according to various embodiments.

FIG. 7B illustrates a block diagram of an example base station, according to various embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

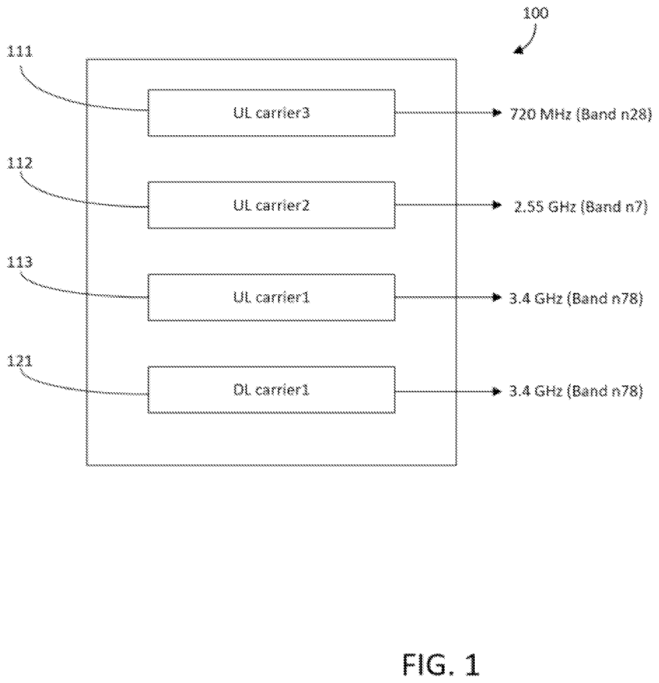

In some embodiments for a first Cell design, one Cell includes of 1 DL carrier and n UL carriers, where n is greater than or equal to 2. These UL carriers may be supplementary carriers, or any other type of carrier. Then UL carriers may be in the same band, or some or all of then UL carriers may be in different bands. FIG. 1 is a schematic diagram of a design of a Cell 100, according to a SUL-related embodiment. As shown in FIG. 1, the network (i.e., one or more BS) configures a Cell 100 (e.g., Cell A) with 3 UL carriers, denoted as UL carrier1 111, UL carrier2 112, and UL carrier3 113, and 1 DL carrier, denoted as DL carrier1 121. DL carrier1 121 and UL carrier1 111 are in Band n78 with center frequency 3.4 GHz. UL carrier2 112 is in Band n7 with center frequency 2.55 GHz, and UL carrier3 113 is in Band n28 with center frequency 720 MHZ. Detailed information for each band can be found in 3GPP RAN4 specifications (e.g., TS 38.101-1).

Configuring n UL carriers in one Cell allow gNB to better manage and make the best of limited wireless communication resources. In addition, different network operators may own different frequency bands, such that configuring cells from the same or different bands in one cell can fit the demands from different operators. In one embodiment, the n UL carriers are within the same frequency range (i.e., Frequency Range 1 (FR1) or Frequency Range 2 (FR2)), while in other embodiments, the n UL carriers and 1 DL carrier in the Cell are within the same frequency range (i.e., FR1 and FR2). These frequency ranges are defined in 3GPP specification (e.g., TS38.101-1). Referring again to FIG. 1, based on current 3GPP specification, the frequency range from 410 MHz to 7125 MHz is defined as FR1. Thus, UL carrier1 111 (band n78), UL carrier2 112 (band n7, UL carrier3 113 (band n28), and DL carrier1 121 (band n78) are all within FR1. Requirements in some 3GPP RF specifications (e.g., TS38.101-1) are, in many cases, defined separately for different Frequency Ranges (FR). If all UL carriers are within the same FR, gNB implementation is simplified. In addition, if the UL carrier and DL carrier are within the same FR, the UE can derive the UL spatial information based on the DL reference signals.

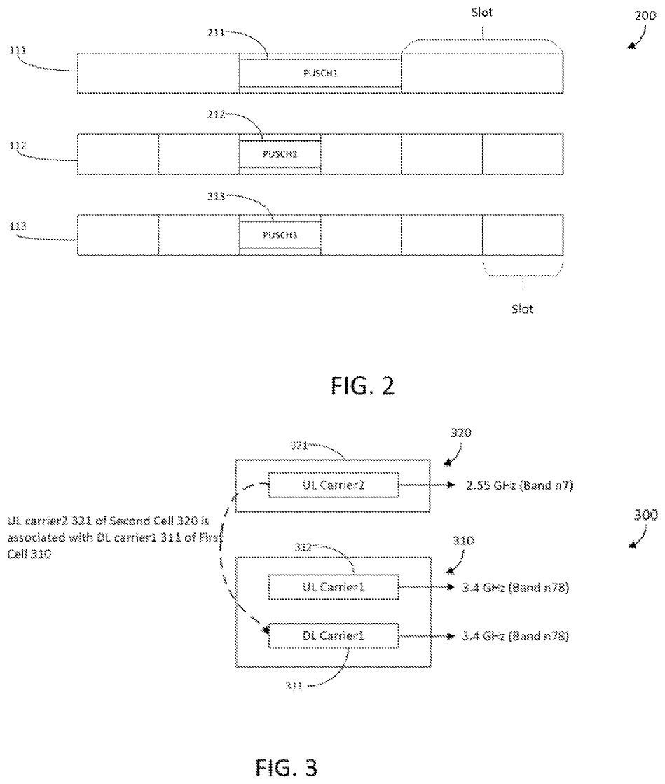

FIG. 2 is a schematic diagram illustrating simultaneous UL transmission in 3 UL carriers in the same cell, according to an exemplary embodiment. In the embodiment shown in FIG. 2, the UL carrier1 of FIG. 2 corresponds to UL carrier1 111 of FIG. 1, the UL carrier2 of FIG. 2 corresponds to UL carrier2 112 of FIG. 1, and UL carrier3 of FIG. 2 corresponds to UL carrier3 113 of FIG. 1. As shown in FIG. 2, the Sub-Carrier Spacing (SCS) of UL carrier1 111 is 15 KHz, the SCS of UL carrier2 112 is 30 KHz, and the SCS of UL carrier3 113 is 30 KHz. gNB schedules a Physical Uplink Shared Channel (PUSCH) for each UL carrier, denoted as PUSCH1 211, PUSCH2 212, and PUSCH 213 in UL carrier1 111, UL carrier2 112, and UL carrier3 113 respectively. PUSCH1 211, PUSCH2 212, and PUSCH3 213 overlap in the time domain, but the UE supports transmitting PUSCH1 211, PUSCH2 212, and PUSCH3 213 simultaneously (i.e., the BS receives UL information from the UE in the n UL carriers simultaneously). Allowing the UE to transmit UL transmissions in different UL carrier in the same Cell can increase the system throughput.

In some embodiments, Medium Access Control (MAC)—Control Element (CE) is used to activate or deactivate m UL carrier(s) of the n UL carriers, in which m is a positive integer and smaller than or equal to the value of n. Referring again to FIG. 1, a MAC-CE with UL carrier index can be transmitted to the UE to activate or deactivate one or more UL carriers. When the indices of UL carrier2 112 and UL carrier3 113 are included in the MAC-CE for cell 100, and one bit in the MAC-CE indicates to deactivate one or more UL carriers, then the UE deactivates UL carrier2 112 and UL carrier3 113. In this case, only UL carrier1 111 is activated. Later, when the index of UL carrier2 112 is included in the MAC-CE for cell 100 and one bit in the MAC-CE indicates to active UL carrier, then the UE activates UL carrier2 112. In this case, only UL carrier1 111 and UL carrier2 112 are activated. In other embodiments, Downlink Control Information (DCI) is used to activate or deactivate m UL carrier(s) of the n UL carriers, in which m is a positive integer and smaller than or equal to the value of n. Referring again to FIG. 1, when the UE receives a DCI indicating to deactivate UL carrier2 112 and UL carrier3 113, the UE deactivates UL carrier2 112 and UL carrier3 113. In this case, only UL carrier1 111 is activated. Later, when the UE receives a DCI indicating to activate UL carrier2 112, the UE activates UL carrier2 112. In this case, only UL carrier1 111 and UL carrier2 112 are activated. Using MAC or DCI to activate or deactivate UL carrier(s) dynamically, the number of activated UL carriers can be adapted to the traffic load.

In some embodiments, if the Cell is deactivated, all of the UL carriers on the Cell are similarly deactivated. Referring again to FIG. 1, assuming that UL carrier1 111, UL carrier2 112, and UL carrier3 113 are all active, but cell 100 is later deactivated, then all three UL carriers (i.e., UL carrier1 111, UL carrier2 112, and UL carrier3 113) are all deactivated. Alternatively, in other embodiments, if the Cell is activated, all of the UL carriers on the Cell are similarly activated. Referring again to FIG. 1, when the cell 100 is activated, all three UL carriers (i.e., UL carrier1 111, UL carrier2 112, and UL carrier3 113) on the cell 100 are activated. In this case, by activating the cell, the network (i.e., one or more BS) can boost the UL throughput immediately and with minimum delay.

In some embodiments, the Cell can be deactivated only in response to determining that a single UL carrier is activated in the cell. Referring again to FIG. 1, in response to determining that the UL carrier1 111, UL carrier2 112, and UL carrier3 113 are all active, then cell 100 cannot be deactivated. Later, in response to determining that UL carrier2 112 and UL carrier3 113 have been deactivated, the cell 100 is able to be deactivated. In this case, the network can decrease the number of UL carriers gradually in order to avoid a sudden dramatic change of UL throughput.

In some embodiments, each UL carrier has one UL carrier index, and the target UL carrier for UL transmission is indicated by the UL carrier indicator in DCI. This UL carrier indicator in DCI corresponds to the UL carrier index. Referring again to FIG. 1, when a DCI schedules a PUSCH, and the UL carrier indicator in this DCI indicates UL carrier2 112, then the PUSCH is scheduled in UL carrier2 112.

In some embodiments of a second Cell design, a second Cell (i.e., Cell B) is only configured with a single UL carrier and is associated with the DL carrier in the first Cell (i.e., Cell A). FIG. 3 is a schematic diagram of a design 300 of Cells, according to a first CA-related embodiment. As shown in FIG. 3, a first cell 310 (i.e., Cell A) is configured with one DL carrier (i.e., DL carrier1 311) and one UL carrier (i.e., UL carrier1 312). Both DL carrier1 311 and UL carrier1 312 are in Band n78, and the network (i.e., one or more BS) configures both UL-related configurations and DL-related for the first cell 310 for the UE. A second cell 320 (i.e., Cell B) is configured with a single UL carrier (i.e., UL carrier2 321), and without a DL carrier. UL carrier2 321 is in Band n7. As such, the network (i.e., one or more BS) configures UL-related configurations for the second cell 320, and configures the association between UL carrier2 321 and DL carrier1 311. These UL-related configurations include at least one of UL Bandwidth Part (BWP) configurations, PUSCH configurations, Physical Uplink Control Channels (PUCCH), Sounding Reference Signal (SRS) configurations, Random Access Channel (RACH) configurations, and power control configurations. These DL-related configurations include at least one of DL BWP configurations, Physical Downlink Shared Channel (PDSCH) configurations, Physical Downlink Control Channel (PDCCH) configurations (which include CORESET configurations and search space configurations), Channel State Information Reference Signal (CSI-RS) configurations, Synchronization Signal Block (SSB) configurations, System Information Block (SIB) configurations, and paging configurations.

In some embodiments, Cell B uses the DL carrier in Cell A to transmit the DL signals/channels relevant to Cell B. These DL signals/channels that are relevant to Cell B include at least one of: a) PDCCH scheduling PUSCH in UL carrier2; b) PDCCH scheduling SRS in UL carrier2; c) PDCCH scheduling PDSCH for Cell B; d) PDSCH for Cell B; e) CSI-RS for Cell B; f) PDCCH triggering Physical Random Access Channel (PRACH) for Cell B; g) Primary Synchronization Signal (PSS) and Secondary Synchronization Signal (SSS) for Cell B; h) Physical Broadcast Channel (PBCH); i) Cell B's Phase-Tracking Reference Signal (PT-RS); j) Dedicated Demodulation Reference Signal (DM-RS) for PDCCH scheduling PUSCH or SRS in UL carrier2; k) DM-RS for PDCCH scheduling PDSCH for Cell B; and 1) DMRS for PDSCH for Cell B. Referring to FIG. 3, the PDCCH scheduling PUSCH in UL carrier2 321 is transmitted in DL carrier1 311 in the first cell 310, and the PDCCH scheduling SRS in UL carrier2 321 is transmitted in DL carrier1 311 in the first cell 310.

In some embodiments, the UL carrier1 in Cell A and UL carrier2 in Cell B are within the same frequency range (i.e., FR1 or FR2). Referring again to FIG. 3, both UL carrier1 312 and UL carrier2 321 are within FR1. In other embodiments, the UL carrier1 and DL carrier1 in Cell A and UL carrier2 in Cell B are within the same frequency range (i.e., FR1 or FR2). Referring again to FIG. 3, UL carrier1 312, UL carrier2 321, and DL carrier1 311 are within FR1. Requirements in some 3GPP RF specifications (e.g., TS38.101-1) are, in many cases, defined separately for different FR. If all UL carriers are within the same FR, gNB implementation is simplified. In addition, if the UL carrier and DL carrier are within the same FR, the UE can derive the UL spatial information based on the DL reference signals.

In some embodiments, at most n UL carriers are associated with DL carrier1 in Cell A, where n is a positive integer and whose value is based on UE capability or network configuration. Referring again to FIG. 3, when the UE reports that the UE can support at most one UL carrier associated with DL carrier1 311 in the first cell 310, then the network (i.e., one or more BS) can configure at most one cell (e.g., the second cell 320) with one UL carrier (e.g., UL carrier2 321) associated with the DL carrier (e.g., DL carrier 1 311) in another cell (e.g., the second cell 310).

In some embodiments, when the UE receives an indication to activate Cell B, only UL carrier2 is activated. However, Cell B can only be activated if Cell A has already been activated. In other embodiments, Cell A can be deactivated only when all the cells that are configured with only UL carriers and are associated with Cell A (e.g., Cell B) have been deactivated. Referring to FIG. 3, the first cell 310 can be de-activated only when the second cell 320 has been deactivated. In further embodiments, all cells that are configured with a single UL carrier and are associated with Cell A are activated when Cell A is activated. Referring to FIG. 3, the second cell 320 is activated when the first cell 310 activated. In other words, once the UE receives an indication to activate the first cell 310, the UE will activate both the first cell 310 and the second cell 320. In yet further embodiments, Cell A is activated when Cell B is activated.

In some embodiments, only one of Cell A or Cell B can be configured with SRS antenna switching. Once SRS antenna switching is triggered, the UE needs to switch the DL antennas for transmitting SRS. Because Cell A and Cell B share the same DL carrier, the UE is unable to perform SRS antenna switching for both Cell A and Cell B simultaneously. As such, the UE is not expected to be configured with SRS antenna switching in both Cell A and Cell B. In other embodiments, if Cell A or Cell B is configured as the source cell for SRS carrier switching via RRC signaling (e.g., srs-SwitchFromServCelllndex), UE is not expected to transmit any uplink transmission in both Cell A and Cell B during the time duration when UE is performing SRS carrier switching.

In some embodiments, when the network (i.e., one or more BS) indicates a slot format for Cell B for the UE, the UE determines the UL symbols of Cell B based on this slot format and determines the corresponding flexible symbols and DL symbols of Cell B based on the slot format for Cell A (if provided). The slot format can be indicated via higher layer configuration or via Slot Format Indicator (SFI). In other embodiments, when the network (i.e., one or more BS) indicates slot format for Cell B for the UE, the UE determines the UL symbols and flexible symbols of Cell B based on this slot format, and determines the corresponding DL symbols of Cell B based on the slot format for Cell A (if provided). The slot format can be indicated via higher layer configuration or via SFI.

In some embodiments, when the UE receives a DCI indicating a dormant BWP for Cell B, the UE does not switch the active DL BWP of Cell A to dormant BWP. However, the UE performs the corresponding behaviors related to UL carrier2 as if Cell B's downlink BWP had been switched to dormant BWP. In other embodiments, when the UE receives a DCI indicating a dormant BWP for Cell B, the UE does not switch the active DL BWP of Cell A to dormant BWP. However, the UE performs the corresponding behaviors, as if Cell B's DL BWP had been switched to a non-dormant BWP.

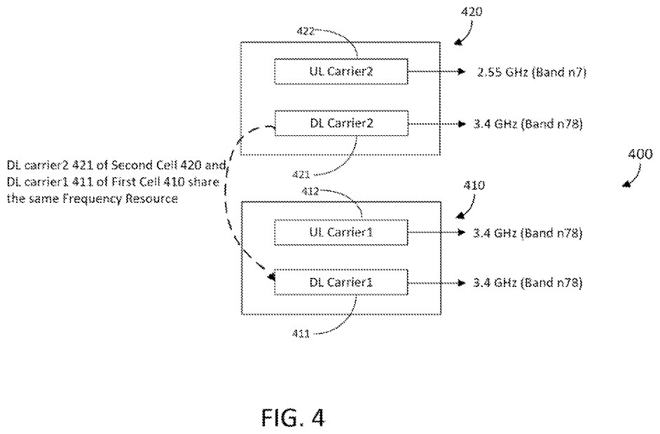

In some embodiments of a third Cell design, each of a first cell and a second cell are configured with one DL carrier and one UL carrier. FIG. 4 is a schematic diagram of a design 400 of Cells, according to a second CA-related embodiment. As shown in FIG. 4, a first cell 410 (i.e., Cell A) is configured with one DL carrier1 411 and one UL carrier1 412. Both DL carrier1 411 and UL carrier1 412 are in Band n78, and the network (i.e., one or more BS) configures both UL-related configurations and DL-related configurations for the first cell 410 for UE. A second cell 420 is configured with one DL carrier2 421 and one UL carrier2 422. DL carrier2 421 is in Band n78, and UL carrier2 422 is in Band n7, such that DL carrier1 411 and DL carrier2 421 share the same frequency resource. The network (i.e., one or more BS) configures both UL-related configurations and DL-related configurations for the second cell 420 for UE.

In some embodiments, the DL carrier and UL carrier of Cell B are in different frequency bands. Referring to FIG. 4, DL carrier2 421 is in Band n78 and UL carrier2 422 is in Band n7, such that DL carrier2 421 and UL carrier2 422 are from different bands. The network (i.e., one or more BS) can flexibly combine the DL carrier and UL carrier from different bands into one cell to adapt to different traffic demands. In other embodiments, Cell A and Cell B are within the same FR (i.e., FR1 or FR2). Referring again to FIG. 4, DL carrier1 411 and UL carrier1 412 of the first cell 410 and DL carrier2 421 of the second cell 420 are in Band n78. UL carrier2 422 of the second cell 420 is in Band n7. Because both Band n7 and Band n78 are within FR1, then both the first cell 410 and the second cell 420 are within FR1.

In some embodiments, a center frequency of an active DL BWP of Cell B and a center frequency of an active UL BWP of Cell B are different. In some embodiments, at most n cells whose DL carriers share the same FR can be configured to the UE, where n is a positive integer and based on UE capability or network configuration. Referring again to FIG. 4, when the UE reports that it can be configured with up to 2 cells whose DL carriers share the same FR (i.e., n=2), the network (i.e., one or more BS) configures the first cell 410 and the second cell 420 to the UE such that DL carrier2 421 of the second cell 420 and DL carrier1 411 of the first cell 410 share the same FR (i.e., FR1).

In some embodiments, neither Cell A nor Cell B can receive DL signals/channels (i.e., transmissions) during a time when either Cell A or Cell B is performing SRS antenna switching. Once SRS antenna switching is triggered, the UE switches the DL antennae for transmitting SRS. In this case, the UE is unable to receive any signals/channels for Cell A and Cell B during the time when one of Cell A or Cell B is performing SRS antenna switching.

In some embodiments, when the network (i.e., one or more BS) indicates slot format for both Cell A and Cell B, the total length of UL symbols of Cell A in each slot is equal to that of the total length of UL symbols in Cell B. In this case, the UL symbols of UL carrier1 of Cell A and the UL symbols of UL carrier2 of Cell B are aligned. Because DL carrier1 of Cell A and DL carrier2 of Cell B share the same FR, when UL symbols of UL carrier1 and UL carrier2 are not aligned, there is cross-link interference. Because DL carrier1 and Cell A and DL carrier2 of Cell B share the same FR, aligning the DL symbols of Cell A and Cell B in order to avoid the cross-link interference is preferred. In this case, the UE can determine the DL symbols based on the slot format of Cell A or Cell B. In some embodiments, when the network (i.e., one or more BS) indicates slot format for both Cell A and Cell B, the DL symbols are determined based on the slot format. Alternatively, in other embodiments, when the network (i.e., one or more BS) indicates slot format for both Cell A and Cell B, the DL symbols are determined based on the slot format of Cell B. In some of these embodiments, the network (i.e., one or more BS) configures the same slot format for Cell A and Cell B. In further embodiments, all symbols of Cell B are configured as UL symbols, in order increase the UL throughput of Cell B.

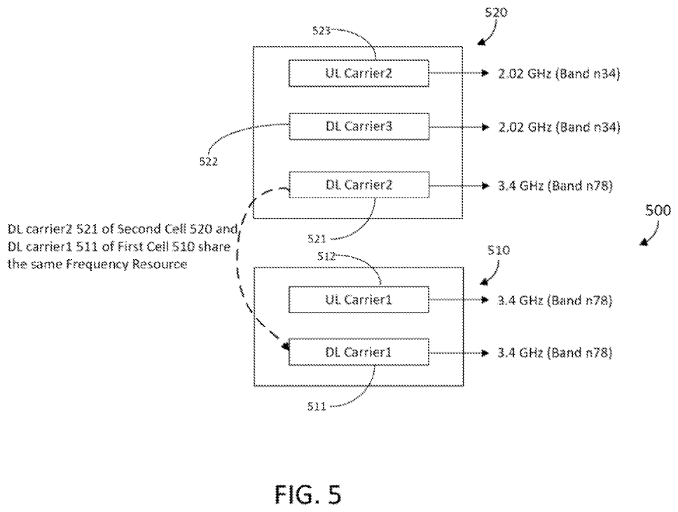

In some embodiments of a fourth Cell design, Cell A is configured with one DL carrier and one UL carrier, while Cell B is configured with one UL carrier and 2 DL carriers. FIG. 5 is a schematic diagram of a design 500 of Cells, according to a third CA-related embodiment. As shown in FIG. 5, a first cell 510 is configured with DL carrier1 511 and UL carrier 512, and a second cell 520 is configured with DL carrier2 521, DL carrier3 522, and UL carrier2 523. DL carrier1 511, UL carrier1 512, and DL carrier2 521 are in Band n78, such that DL carrier2 521 of the second cell 520 and DL carrier1 511 of the first cell 511 share the same FR, while DL carrier3 522 and UL carrier2 523 are in Band n34.

In some embodiments in which Cell B has one UL carrier and two DL carriers, such as the embodiment shown in FIG. 5, one of the DL carriers has the same center frequency as the UL carrier, and the other DL carrier shares the same FR with Cell A's DL carrier. In some of these embodiments, the two DL carriers of Cell B are in different bands. In some embodiments, the slot format of DL carrier3 and UL carrier2 are determined based on the slot formation indicated for Cell B, and in some embodiments, the slot format of DL carrier2 is determined based on the slot format indicated for Cell A.

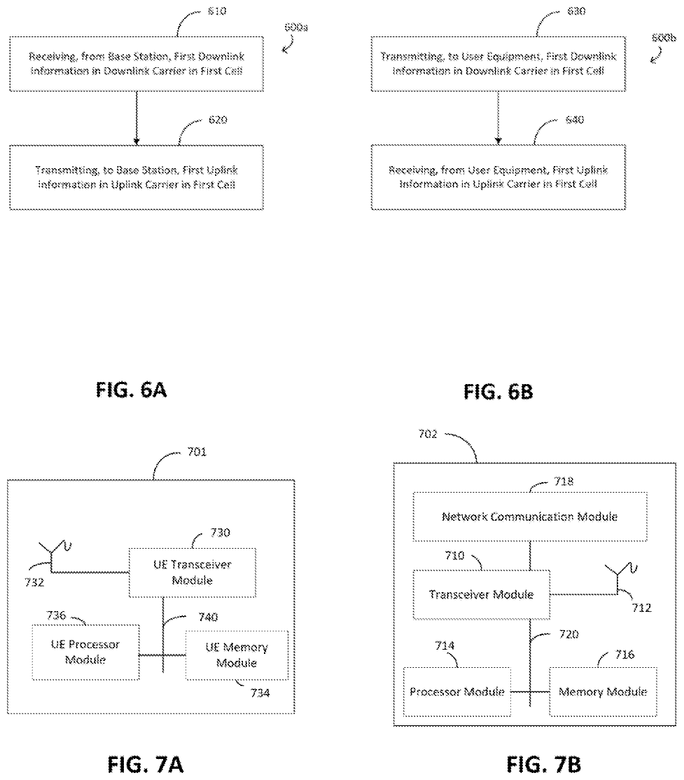

FIG. 6A is a flowchart diagram illustrating an example wireless communication method 600a, according to various arrangements. Method 600a can be performed by a UE, and begins at block 610 where the UE receives, from a BS, first DL information in a DL carrier in a first cell. At block 620, the UE transmits, to the BS, first UL information in a UL carrier in the first cell.

FIG. 6B is a flowchart diagram illustrating an example wireless communication method 600b, according to various arrangements. Method 600b can be performed by a network (e.g., BS), and begins at block 630 where the network transmits, to a UE, first DL information in a DL carrier in a first cell. At block 640, the BS receives, from the UE, first UL information in a UL carrier in the first cell.

FIG. 7A illustrates a block diagram of an example UE 701, in accordance with some embodiments of the present disclosure. FIG. 7B illustrates a block diagram of an example BS 702, in accordance with some embodiments of the present disclosure. The UE 701 (e.g., a wireless communication device, a terminal, a mobile device, a mobile user, and so on) is an example implementation of the UEs described herein, and the BS 702 is an example implementation of the BS described herein.

The BS 702 and the UE 701 can include components and elements configured to support known or conventional operating features that need not be described in detail herein. In one illustrative embodiment, the BS 702 and the UE 701 can be used to communicate (e.g., transmit and receive) data symbols in a wireless communication environment, as described above. For instance, the BS 702 can be a BS (e.g., gNB, eNB, and so on), a server, a node, or any suitable computing device used to implement various network functions.

The BS 702 includes a transceiver module 710, an antenna 712, a processor module 714, a memory module 716, and a network communication module 718. The module 710, 712, 714, 716, and 718 are operatively coupled to and interconnected with one another via a data communication bus 720. The UE 701 includes a UE transceiver module 730, a UE antenna 732, a UE memory module 734, and a UE processor module 736. The modules 730, 732, 734, and 736 are operatively coupled to and interconnected with one another via a data communication bus 740. The BS 702 communicates with the UE 701 or another BS via a communication channel, which can be any wireless channel or other medium suitable for transmission of data as described herein.

As would be understood by persons of ordinary skill in the art, the BS 702 and the UE 701 can further include any number of modules other than the modules shown in FIGS. 7A and 7B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the UE transceiver 730 includes a radio frequency (RF) transmitter and a RF receiver each including circuitry that is coupled to the antenna 732. A duplex switch (not shown) may alternatively couple the RF transmitter or receiver to the antenna in time duplex fashion. Similarly, in accordance with some embodiments, the transceiver 710 includes an RF transmitter and a RF receiver each having circuitry that is coupled to the antenna 712 or the antenna of another BS. A duplex switch may alternatively couple the RF transmitter or receiver to the antenna 712 in time duplex fashion. The operations of the two-transceiver modules 710 and 730 can be coordinated in time such that the receiver circuitry is coupled to the antenna 732 for reception of transmissions over a wireless transmission link at the same time that the transmitter is coupled to the antenna 712. In some embodiments, there is close time synchronization with a minimal guard time between changes in duplex direction.

The UE transceiver 730 and the transceiver 710 are configured to communicate via the wireless data communication link, and cooperate with a suitably configured RF antenna arrangement 712/732 that can support a particular wireless communication protocol and modulation scheme. In some illustrative embodiments, the UE transceiver 730 and the transceiver 710 are configured to support industry standards such as the Long Term Evolution (LTE) and emerging 5G standards, and the like. It is understood, however, that the present disclosure is not necessarily limited in application to a particular standard and associated protocols. Rather, the UE transceiver 730 and the BS transceiver 710 may be configured to support alternate, or additional, wireless data communication protocols, including future standards or variations thereof.

The transceiver 710 and the transceiver of another BS (such as but not limited to, the transceiver 710) are configured to communicate via a wireless data communication link, and cooperate with a suitably configured RF antenna arrangement that can support a particular wireless communication protocol and modulation scheme. In some illustrative embodiments, the transceiver 710 and the transceiver of another BS are configured to support industry standards such as the LTE and emerging 5G standards, and the like. It is understood, however, that the present disclosure is not necessarily limited in application to a particular standard and associated protocols. Rather, the transceiver 710 and the transceiver of another BS may be configured to support alternate, or additional, wireless data communication protocols, including future standards or variations thereof.

In accordance with various embodiments, the BS 702 may be a BS such as but not limited to, an eNB, a serving eNB, a target eNB, a femto station, or a pico station, for example. The BS 702 can be an RN, a DeNB, or a gNB. In some embodiments, the UE 701 may be embodied in various types of user devices such as a mobile phone, a smart phone, a personal digital assistant (PDA), tablet, laptop computer, wearable computing device, etc. The processor modules 714 and 736 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 714 and 736, respectively, or in any practical combination thereof. The memory modules 716 and 734 may be realized as RAM memory, flash memory, ROM memory, EPROM memory, EEPROM memory, registers, a hard disk, a removable disk, a CD-ROM, or any other form of storage medium known in the art. In this regard, memory modules 716 and 734 may be coupled to the processor modules 714 and 736, respectively, such that the processors modules 714 and 736 can read information from, and write information to, memory modules 716 and 734, respectively. The memory modules 716 and 734 may also be integrated into their respective processor modules 714 and 736. In some embodiments, the memory modules 716 and 734 may each include a cache memory for storing temporary variables or other intermediate information during execution of instructions to be executed by processor modules 714 and 736, respectively. Memory modules 716 and 734 may also each include non-volatile memory for storing instructions to be executed by the processor modules 714 and 736, respectively.

The network communication module 718 generally represents the hardware, software, firmware, processing logic, and/or other components of the BS 702 that enable bi-directional communication between the transceiver 710 and other network components and communication nodes in communication with the BS 702. For example, the network communication module 718 may be configured to support internet or WiMAX traffic. In a deployment, without limitation, the network communication module 718 provides an 502.3 Ethernet interface such that the transceiver 710 can communicate with a conventional Ethernet based computer network. In this manner, the network communication module 718 may include a physical interface for connection to the computer network (e.g., Mobile Switching Center (MSC)). In some embodiments, the network communication module 718 includes a fiber transport connection configured to connect the BS 702 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
transmitting, by a base station, first downlink information to a wireless communication device in a downlink carrier in a first cell; and
receiving, by the base station, first uplink information from the wireless communication device in an uplink carrier in the first cell.

2. The wireless communication method of claim 1, wherein
the uplink carrier comprises N uplink carriers; and
N is an integer greater or equal to 2.

3. The wireless communication method of claim 2, wherein at least one of:
the N uplink carriers are in a same frequency band or in different frequency bands;
the N uplink carriers are in a same frequency range;
the base station receives the first uplink information from the wireless communication device in the N uplink carriers simultaneously;
the N uplink carriers are deactivated in response to the first cell being deactivated; or
the first cell is capable of being deactivated when one of the N uplink carriers is activated in the first cell.

4. The wireless communication method of claim 2, further comprising one of:
transmitting, by the base station to the wireless communication device, an indication that indicates activation or deactivation of M uplink carriers of the N uplink carriers, wherein M is a positive integer, and M is equal to or less than N; or
transmitting, by the base station to the wireless communication device, Downlink Control Information (DCI), the DCI comprises an uplink carrier index indicating a scheduled uplink carrier of the N uplink carriers.

5. The wireless communication method of claim 1, further comprising receiving, by the base station from the wireless communication device, second uplink information in an uplink carrier of a second cell, wherein the second cell is associated with the downlink carrier of the first cell.

6. The wireless communication method of claim 5, further comprising one of:
transmitting, by the base station to the wireless communication device, second downlink information of the second cell using the downlink carrier of the first cell;
indicating, by the base station to the wireless communication device, a slot format for the second cell, wherein the wireless communication device determines uplink symbols of the second cell based on the slot format for the second cell;
determining, by the wireless communication device, at least one of flexible symbols or downlink symbols for the second cell based on a slot format for the first cell;
indicating, by the base station to the wireless communication device, the slot format for the second cell, wherein the wireless communication device determines at least one of the uplink symbols or the flexible symbols of the second cell based on the slot format for the second cell;
determining, by the wireless communication device, the downlink symbols for the second cell based on the slot format for the first cell; or
indicating, by the base station to the wireless communication device, an indication to update dormancy of the first cell or the second cell, wherein the wireless communication device updates dormancy of both the first cell and the second cell in response to receiving the indication.

7. The wireless communication method of claim 5, wherein at least one of:
the uplink carrier of the second cell and one of the uplink carrier of the first cell are within a same frequency range;
at most N uplink carriers are associated with the downlink carrier of the first cell, wherein N is a positive integer, and N is determined based on capability of the wireless communication device or base station configuration;
the second cell is activated when the first cell has already been activated;
the first cell is configured to be deactivated when all cells associated with the first cell have already been deactivated, wherein the all cells comprises the second cell; or
the first cell is deactivated when all cells with one or more uplink carriers that are associated with the downlink carrier of the first cell have already been deactivated, wherein the all cells comprises the second cell.

8. The wireless communication method of claim 1, further comprising transmitting, by the base station to the wireless communication device, second downlink information in a downlink carrier of a second cell, wherein the downlink carrier of the first cell and the downlink carrier of the second cell share a same frequency resource.

9. The method of claim 8, further comprising one of:
indicating, by the base station to the wireless communication device, a first slot format for the first cell and a second slot format for the second cell, wherein a total length of the uplink symbols in each slot of the first cell is equal to a total length of the uplink symbols in each slot of the second cell; or
indicating, by the base station to the wireless communication device, a slot format for both the first cell and the second cell, wherein downlink symbols of the first cell and the second cell are determined based on the slot format.

10. The wireless communication method of claim 1, further comprising:
transmitting, by the base station to the wireless communication device, second downlink information in two or more downlink carriers of a second cell; and
receiving, by the base station from the wireless communication device, second uplink information in an uplink carrier of the second cell, wherein one of the two or more downlink carriers has a center frequency that is same as has a center frequency the uplink carrier of the second cell, and another one of the two or more downlink carriers shares a same frequency resource with the downlink carrier of the first cell.

11. A wireless communication method, comprising:
receiving, by a wireless communication device from a base station, first downlink information in a downlink carrier in a first cell; and
transmitting, by the wireless communication device to the base station, first uplink information in an uplink carrier in the first cell.

12. The wireless communication method of claim 11, wherein
the uplink carrier comprises N uplink carriers; and
N is an integer greater or equal to 2.

13. The wireless communication method of claim 12, wherein at least one of:
the N uplink carriers are in a same frequency band or in different frequency bands;
the N uplink carriers are in a same frequency range;
the wireless communication device transmits the first uplink information to the base station in the N uplink carriers simultaneously;
the N uplink carriers are deactivated in response to the first cell being deactivated; or
the first cell is capable of being deactivated when one of the N uplink carriers is activated in the first cell.

14. The wireless communication method of claim 12, further comprising one of:
receiving, by the wireless communication device from the base station, an indication that indicates activation or deactivation of M uplink carriers of the N uplink carriers, wherein M is a positive integer, and M is equal to or less than N; or
receiving, by the wireless communication device from the base station, Downlink Control Information (DCI), the DCI comprises an uplink carrier index indicating a scheduled uplink carrier of the N uplink carriers.

15. The wireless communication method of claim 11, further comprising transmitting, by the wireless communication device to the base station, second uplink information in an uplink carrier of a second cell, wherein the second cell is associated with the downlink carrier of the first cell.

16. The wireless communication method of claim 15, further comprising one of:
receiving, by the wireless communication device from the base station, second downlink information of the second cell using the downlink carrier of the first cell;
receiving, by the wireless communication device from the base station, an indication of a slot format for the second cell, wherein the wireless communication device determines uplink symbols of the second cell based on the slot format for the second cell;
determining, by the wireless communication device, at least one of flexible symbols or downlink symbols for the second cell based on a slot format for the first cell;
receiving, by the wireless communication device from the base station, the indication of the slot format for the second cell, wherein the wireless communication device determines at least one of the uplink symbols or the flexible symbols of the second cell based on the slot format for the second cell;
determining, by the wireless communication device, the downlink symbols for the second cell based on the slot format for the first cell; or
receiving, by the wireless communication device from the base station, an indication to update dormancy of the first cell or the second cell, wherein the wireless communication device updates dormancy of both the first cell and the second cell in response to receiving the indication to update the dormancy.

17. The wireless communication method of claim 15, wherein at least one of:
the uplink carrier of the second cell and one of the uplink carrier of the first cell are within a same frequency range;
at most N uplink carriers are associated with the downlink carrier of the first cell, wherein N is a positive integer, and N is determined based on capability of a wireless communication device or base station configuration;
the second cell is activated when the first cell has already been activated;
the first cell is deactivated when all cells associated with the first cell have already been deactivated, wherein the all cells comprises the second cell; or
the first cell is configured to be deactivated when all cells with one or more uplink carriers that are associated with the downlink carrier of the first cell have already been deactivated, wherein the all cells comprises the second cell.

18. The wireless communication method of claim 11, further comprising receiving, by the wireless communication device from the base station, second downlink information in a downlink carrier of a second cell, wherein the downlink carrier of the first cell and the downlink carrier of the second cell share a same frequency resource.

19. A base station, comprising:
at least one processor configured to:
transmit, via a transceiver, first downlink information to a wireless communication device in a downlink carrier in a first cell; and
receive, via a transceiver, first uplink information from the wireless communication device in an uplink carrier in the first cell.

20. A wireless communication device, comprising:
at least one processor configured to:
receive, via a transceiver from a base station, first downlink information in a downlink carrier in a first cell; and
transmit, via the transceiver to the base station, first uplink information in an uplink carrier in the first cell.
